(19) United States
(12) Patent Application Publication
(10) Pub. No.: US 2010/0262436 A1
(43) Pub. Date: Oct. 14, 2010

(54) MEDICAL INFORMATION SYSTEM FOR COST-EFFECTIVE MANAGEMENT OF HEALTH CARE

(76) Inventors: Ying-Yu Chen, Hershey, PA (US); Jia-Hai Lee, Rockville, MD (US)

Correspondence Address: Jia-Hai Lee, 257 Congressional Lane, Apt. 209, Rockville, MD, 20852, US

(21) Appl. No.: 12/757,991

(22) Filed: Apr. 10, 2010

Related U.S. Application Data
(60) Provisional application No. 61/168,585, filed on Apr. 11, 2009.

(51) Int. Cl. G06Q 10/00; G06Q 50/00

(52) U.S. Cl. 705/3; 705/2

(57) ABSTRACT

The invention is to solve the high cost problems in the current health care system and to increase efficiency and quality of medical care service by using an integrated medical information management system. The invention allows users or patients to manage their own medical information worldwide in a portable device to enhance medication adherence and self-management of personalized health care. A multi-functional medical information center is developed to manage medical information received from various resources to satisfy stakeholders by improving the efficacy, accuracy, and quality of health care information, but simultaneously operated at a cost-effective manner for stakeholders. In addition, the quality control of medical data management will be guarded by a side-by-side comparison technology to warn inconsistent information in medical billing history to prevent medical insurance fraudulent claims. The invention also makes the medical billing system more transparent and patients can find their desired medical doctors, preferred insurance policy, and price comparison of medical products at ease.

### CROSS-REFERENCE TO RELATED APPLICATIONS

This application claims the benefits of U.S. Provisional Application No. 61/168,585, filed Apr. 11, 2009, entitled “A Medical Information System for Health Care Management,” which is incorporated by reference herein in its entirety.

### FIELD OF THE INVENTION

The present invention relates generally to the field of information management. More particularly, the invention relates to a health care information management.

### BACKGROUND OF THE INVENTION

The current system of health care administration requires routine paper work and manpower to process and reinforce the execution of plans, including but not limited to, a reminding phone call to people, a follow-up contact by health care professionals regularly, disputed issues of medical billing, and hand-carrying large volumes of medical record by patients to doctor's office to receive opinions of treatments or medication. Even though large efforts have been implemented into the health care system, the improvement of medication adherence and efficiency of administration is still limited due to outdated information infrastructure.

It has been a long-term problem of medical insurance fraud in current health care billing systems, resulting in mistrust among patients, health care service providers, medical insurance companies, and government investigation agency. Current medical billing system is not sufficient to avoid medical insurance fraud because software package for management of medical record and automatic surveillance software of medical billing are independent in the current health care system.

In the near future, people in this society become more and more relying on self-management of medication to control diseases and health conditions, prevent hospitalization, and improve their quality of life. Medication non-adherence of people, either willful or inadvertent, may fail to refill prescription as directed, prematurely discontinuing medication, or taking outdated medications. In a survey of American age 50 and older, conducted by American Association of Retired Persons (AARP 2004), 25% confessed they did not fill description recommended by their doctors and 40% medication non-adherence of Americans age 50 and older were due to the cost of drugs. Thus, a system to bring affordable drugs to consumers will certainly be able to enhance medication adherence.

In 2002, a study of 325 people at average age of 78 reported that 39% people could not read the prescription labels and 67% did not fully understand the information given to them. There is no clear solution in current health care system to assist senior people with self-management of medication in our society. A creative system to assist self-management of medication in close connection to a patient's primary doctor will be very valuable for senior people.

People at their first time to visit doctors in clinics or hospitals are frequently required to fill out lengthy questionnaire. Many stereotypical questions, such as medical insurance information, family disease history, allergy of food and medicine, and history of surgery are repeated again and again. However, people often fill out inconsistent information for their medical history due to limited time in the doctor's office or even forgetting their medical history, resulting in problems in people's medical record with respect to accuracy and consistency.

The United States spend twice per capita on health care than any other industrialized countries do, with $1 of every $5 of national income going toward health care cost, in particular prescription drugs. The spending of health care is expected from $2 trillion in 2006 to reach $4.2 trillion in 2016, approximately 20 percent of the GDP. Therefore, the current financial structure of Medicaid and Medicare is not sustainable in the future without advancement of technology to transform the present health care management systems.

US baby boomers and other senior people all over the world are close to their retirement ages, but cost of living and medical expenses continue to rise. Although government sponsored Medicare and Medicaid programs provide financial assistance for individuals, personal liability is still a financial burden for people suffering from chronic diseases or living with long-term care plans. Senior people may travel around the world, or even move in and out of US. Thus, an advanced health care management system will be needed in the future to manage mass health care data storage and transmission to meet the future demand of new trend of health care.

Personal genetic information has been used for design of personalized medicine to maintain personal health by formulating personalized diet supplement, selecting methods or medicines for personalized treatment of diseases, and identifying genetic markers for predicting predisposed diseases, social behavior, learning abilities, and personal traits. Medical doctors in current health care system may not have updated knowledge, experience, or time to intepret genetic markers such as personal genetic DNA information called single nucleotide polymorphism (SNP) or biomarkers such as a unique enzyme expression level correlated with disease progression. Many genetic markers or disease related biomarkers require complex computing power of bioinformatics to be identified, which are beyond the scope of the current health care management system. The demand of personalized medicine is increasing due to the new trend of biotechnology advancement, such as DNA sequencing, genotyping of single nucleotide polymorphism, and polymerase chain reaction tests (PCR tests). Thus, a health care system, which is capable of handling complex bioinformatics information of individual persons with stronger computing and analytic power, will be in strong demand because the current health care information system is unable to perform the function.

High health care costs and inadequate access to specialized care in US are enhancing the demands of medical tourism. People travel thousands of miles to India, Thailand, or China for organ transplant and other surgery to receive medical service at dramatically lower costs without waiting time. Thus, a system for secure and fast transmission of medical data is critical for medical tourisms. In fact, a global health care management system is needed to store and transfer people's health care information, including medical record and medical history, for emergent purposes in between US and destination of recipients overseas without system compatibility and/or language translation issues.

Reasons for high costs of prescription drugs and medical devices are partly due to high expenses in business operation, such as marketing and advertising expenses. Thus, a cost-effective health care system is needed to bring buyers or consumers and medical product sellers/manufacturers together to create a supply and demand network with mutual benefits on both sides by reducing drug maker's marketing cost as well as lowering consumer's purchase price of prescription and generic drugs.

In current drug supply chains, many online drug stores sell low quality and unsafe drugs with insufficient amounts of active components or substitute materials. In addition, many generic drug manufacturers in developing countries are lack of rigorous quality and/or safety control systems. The existing vulnerable health care system in US is incapable of dealing with fake drug problems without active duties of law enforcement from government agency like Food and Drug Administration. A system to provide reliable quality of medicines at reasonable prices is a long felt need for consumers.

There is no standard tracking system to monitor post-marketing of drugs and medical devices with respect to safety and effectiveness. When tragedies occur, victims are often suffering from permanent body damage or even loss of their lives. The cause of problems is normally discovered too late, largely due to difficulty and time-consuming of information collection. Thus, an medical information system is needed to perform large data collection rapidly and conduct analysis effectively will be able to avoid tragedies by identifying patterns of early warning sign from immediate feedback of drug or medical device users followed by cumulative data analysis in real time with respect to same parameters used in drug approval process.

This invention of medical information management system is believed to reduce cost or expenses for multiple stakeholders, to enhance the consistency and accuracy of health care data, and to advance health care management at personal levels. However, there are uncertain risk factors from both private insurance carriers and government, who may restrict practice methods or confine distribution of medical information by laws to limit the function of the medical management system. The benefits disclosed here as given examples do not confess as prior art.

### BRIEF SUMMARY OF THE INVENTION

The invented health care information system for medical information management, called MedicSystem, allows medical care related information to be stored accurately and consistently to enhance the quality of stored data.

MedicSystem can distribute information confidentially and rapidly to registered accounts, preferable to be in real time, to make record keeping process more transparent to avoid fraud issues in business transactions, to enhance the safety of drugs and medical devices for users, and/or to provide precise medical image and record for medical tourisms.

The health care information management system is able to bring buyers or consumers and medical product producers/manufacturers together in an effective way to reduce both business operation cost and personal spending in health care.

MedicSystem can be used for personalized health care to enhance medication adherence, self-education to gain updated knowledge in health care and disease treatment, and self-management of medical billing accounts.

In one aspect, the invention is to provide an innovated system to enhance medical care management and medication adherence with the least amount of human resources, so people under Medicare and Medicaid programs can manage their own conditions without hospitalization, which can have considerable impact to improve financial burden of current Medicare and Medicaid programs.

Another aspect of the invention is to reduce expense of medical care and incidents of medical insurance fraud by enhancing the transparency of record keeping and business transactions.

In one objective, the invention is to enhance medication by alarming users to remember taking their medication regularly and transforming data from medication-based sequence into time-based sequence for instruction of drug users.

Another objective of this invention is to assist evaluation of new drugs in clinical trials and monitor post-marketing of drugs and medical devices in compliance of government regulations. There are no known methods able to track multiple drugs simultaneously. The MedicSystem is able to achieve the goal by rapid collection and analysis of patient's feedback and/or report in real time.

Another aspect of this invention is to provide medical record for medical tourists with accurate, secure, and rapid data transmission to designated hospitals or locations using existed telecommunication network including phone line, cable, satellite, or wireless communication methods.

### BRIEF DESCRIPTION OF THE DRAWINGS

FIG. 1. A System of medical information management across different hierarchy in the health care sector.

FIG. 2. Means to access medical information in MedicSystem through personal devices.

FIG. 3. Medical information inflow and outflow within the MedicSystem.

FIG. 4. Medical information flows from a visiting patient at a clinic or hospital to the Medicsystem data center.

FIG. 5. Patients to refill prescription without visiting doctor's offices.

FIG. 6. Medical Information exchange among health care providers, end users, and insurance companies.

FIG. 7. A display of prescription drug and equivalent medicines for cost comparison and warnings.

FIG. 8. Information distributed among health care providers, end users, drug companies, and government officials.

FIG. 9. No paper document is needed to store and retrieve medical record.

FIG. 10. A display of medication alarm from drug-based to time-based sequence.

FIG. 11. Hierarchical structure of registered accounts and information exchange in MedicSystem.

### DETAILED DESCRIPTION OF THE INVENTION

The present invention is a system called MedicSystem as a centralized information center to receive, store, compute, compare, and distribute healthcare related information, including but not limited to, health care regulation and policy, personal medication and medical history, new drug approval and availability, clinical trial data, competitive prices of medical products, medical products for sales, appointment of doctor's visiting, health insurance policy, and medical billings.

All affiliated stakeholders are able to transmit and receive their desired information securely in real time after registration to receive accounts. Stakeholders benefit from MedicSystem include, but not limited to, health care providers, pharmacists, government officials, pharmaceutical product suppliers, health insurance managers, patients, individual end users, foreign visitors, medical tourists, and foreign hospitals

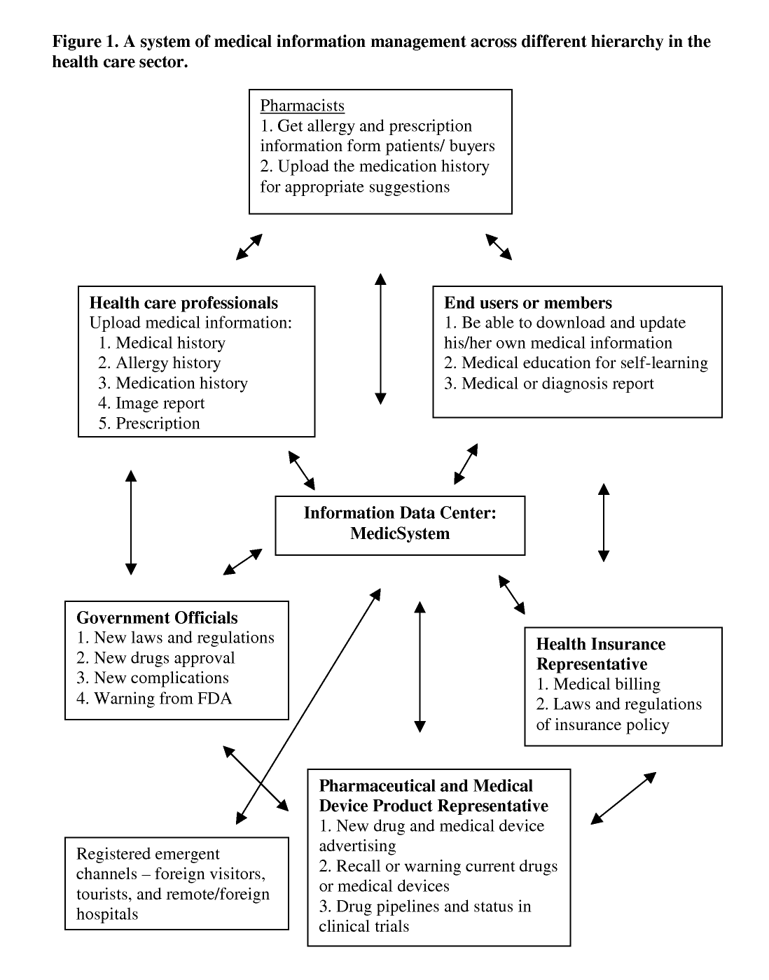

In the embodiment of FIG. 1, the health care information can be distributed among all stakeholders efficiently and accurately, preferable in real time.

The data center, MedicSystem, in FIG. 1 provides compatible processing software to help individual end users manage their own medical information and educate people about disease control and prevention. Individual end users will increase their medication adherence through the automatic reminding program provided by MedicSystem.

MedicSystem is governed via side-by-side data screening technology (U.S. Pat. No. 6,978,420 and 6,560,620) for quality control of accuracy in data entry and retrieval to protect the integrity and consistency of data code, voice, and medical image/video by warning of inconsistence in comparison to stored data. The industrial-standard database query language SQL can also be implemented in MedicSystem for relational database management, providing further security in data entry. In one embodiment, MedicSystem can identify the inconsistency in medical billing early to make the medical billing transaction more transparent, which can reduce dispute in medical reimbursement claims and insurance fraud related litigation. MedicSystem will record “digital signature” of all related data modifications in details.

In the globalization of world economy, foreigners and tourists can travel to US frequently and vise versa, so medical emergency may occur unexpectedly anytime all over the world. Another example to illustrate medical emergency utility of MedicSystem is to provide critical medical care information remotely to treat wounded soldiers on battlefields. Thus, it is important to have a medical data center to store personal medical record, so people can retrieve their medical data any time from any places whenever they need the medical record. A non-English version of medical record can be stored in the MedicSystem data center for emergency purposes to retrieve information from non-English speaking countries.

It is particularly important to manage personal health care information to optimize the effect of personalized health care. For instance, most medical doctors do not practice personal genomic information for personalized medicine because a complex analysis using bioinformatics is not regularly conducted in clinics and hospitals. MedicSystem is also designed to meet future demand of personalized medicine by providing bioinformatics data analysis for people who need them for doctor's opinions in decision-making of health care, including risk profile of disease progression, selection of drugs for disease treatment, and prevention of predisposed diseases based upon biomarkers identified from individual's genomic DNA or a specific protein biomarker isolated from a clinical specimen.

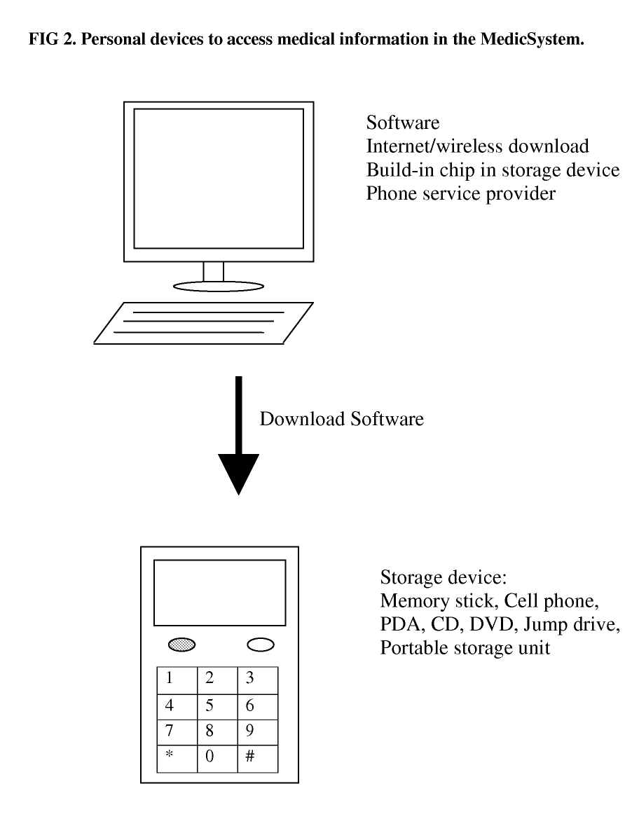

MedicSystem provides software package for users to download through the Internet or wireless (FIG. 2). In this embodiment, an operation software package can be installed into personal devices such as a computer, a PDA, a PDA phone, a cell phone, or any other portable devices able to send and retrieve information in communication with the MedicSystem data center. After installation of the operation software, health care data could be downloaded from the MedicSystem data center to a personal device for self-management.

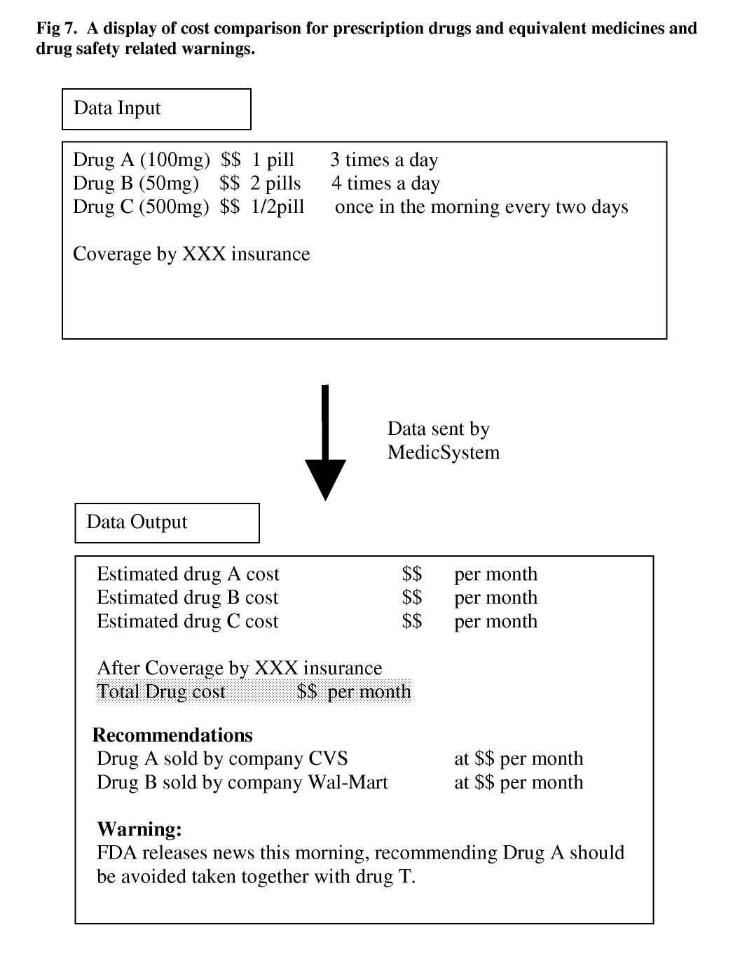

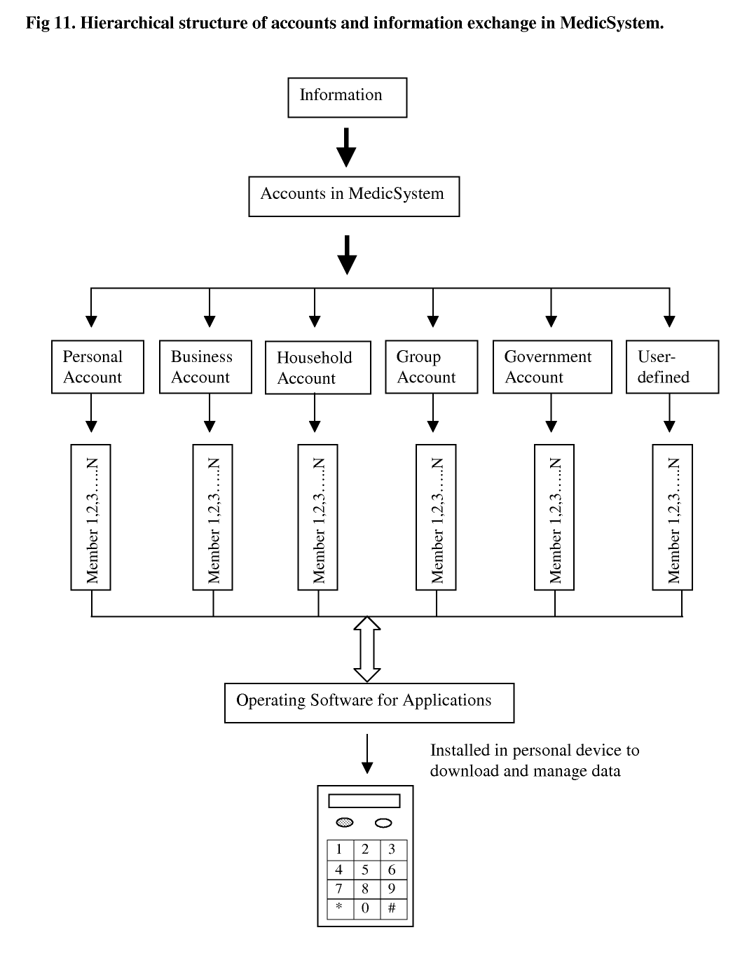

Operating software in connection with the MedicSystem data center will allow authorized users to download and analyze data sequences of personal information in use, and alarm users to take their regular medication on time after setting medication schedule by the user-defined program in a personal device. The operating software program can be written in any general computer programming languages, preferable in JAVA, to support wireless transmission protocols and/or other protocols for Internet-, cable-mediated, and/or satellite-mediated data transmission. Data security can be enhanced by encryption during data transmission, so people cannot decode the information without special skills The knowledge and skill to write a program for automatic control is very common in the field, so one skilled in the art will appreciate immediately in light of this disclosure to show intended use of the technology illustrated in FIGS. 7, 10, and 11.

MedicSystem armed by the side-by-side comparison technology (U.S. Pat. No. 6,978,420 and 6,560,620) and a SQL database management system reinforce health care data management at more restricted conditions to reduce incidents of data entry errors and inconsistency of medical billings, which may lead to intentional insurance fraud or unintentional violation of laws and regulations. Through the automatic recording system, the invisible health insurance management and medical billing process become more transparent. And also, business transactions violating laws and regulations will be significantly reduced due to timely warning of incoherent data or information.

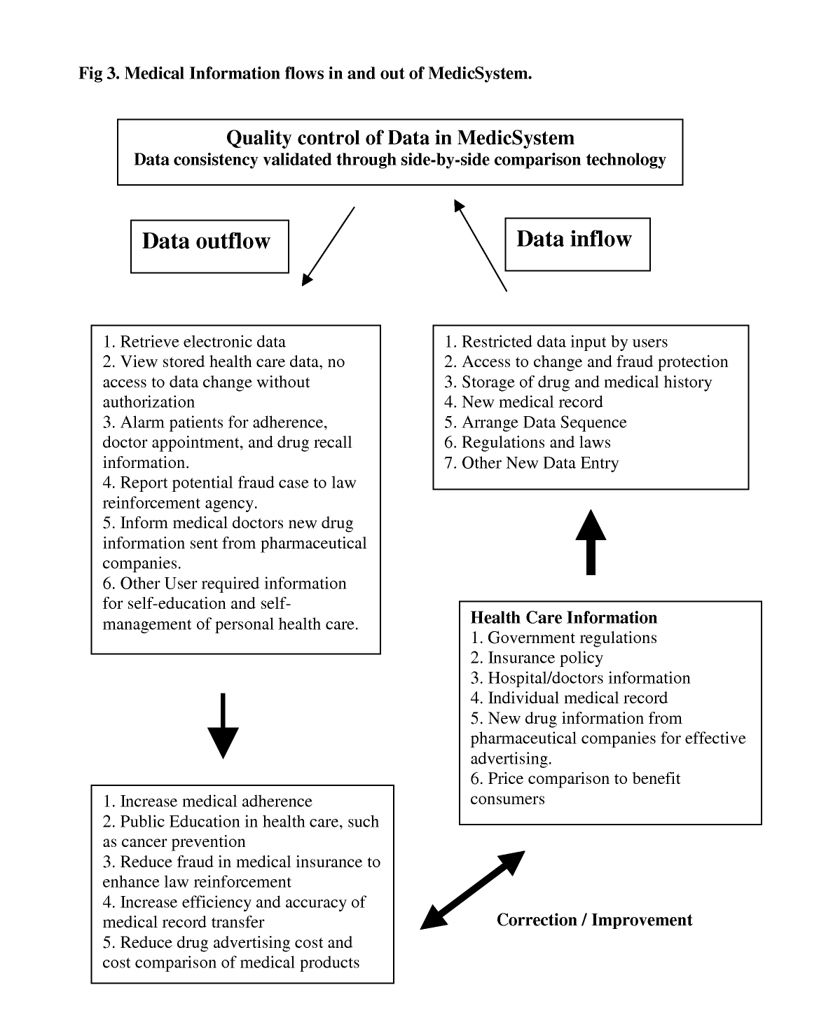

MedicSystem provides comparison of insurance policy premium, hospital and doctor reputation, sales price of medical products including medical devices, drugs, and consumable medical products for long-term care. An embodiment of Medical Information flows in and out of MedicSystem is shown in FIG. 3.

The MedicSystem can distribute all the medical information to appropriate stakeholders efficiently, preferable electronic delivery in real time. When a first-time patient visits a hospital or a clinic doctor's office, the medical care provider can retrieve all medical history of the patient from the MediSystem data center and add (upload) new medical information, such as diagnostic results, medical examination, allergy, medication, exam data report, image exam report, and prescription to the patient's profiles. The medical information can be transmitted from health care service providers to the information data center as soon as a new medical diagnostic report is available.

A pharmacist can retrieve information from the MediSystem data center and prepare for prescription drugs to fill in orders, which can shorten customers' waiting time or no waiting time at all. After a patient picks up the prescription medication, the pharmacist can upload the record to the data center and the co-pay cost can be automatically deducted from the patient's flexible spending account in the MedicSystem data center.

When a patient visits a different hospital or clinic, the new health care provider can retrieve complete personal medical information from the MedicSystem data center. After the first visit of doctor, the health care provider can update and validate the visitor's medical information stored in the system Likewise, an end user, a pharmacist, or other authorized health care provider may retrieve the new medical information as well. MedicSystem can enhance the efficiency of health care management and save unnecessarily medical expenses. Most importantly, it can reduce the mistakes of medical history and rapidly identify the cause when problems occur because all data are saved as digital record.

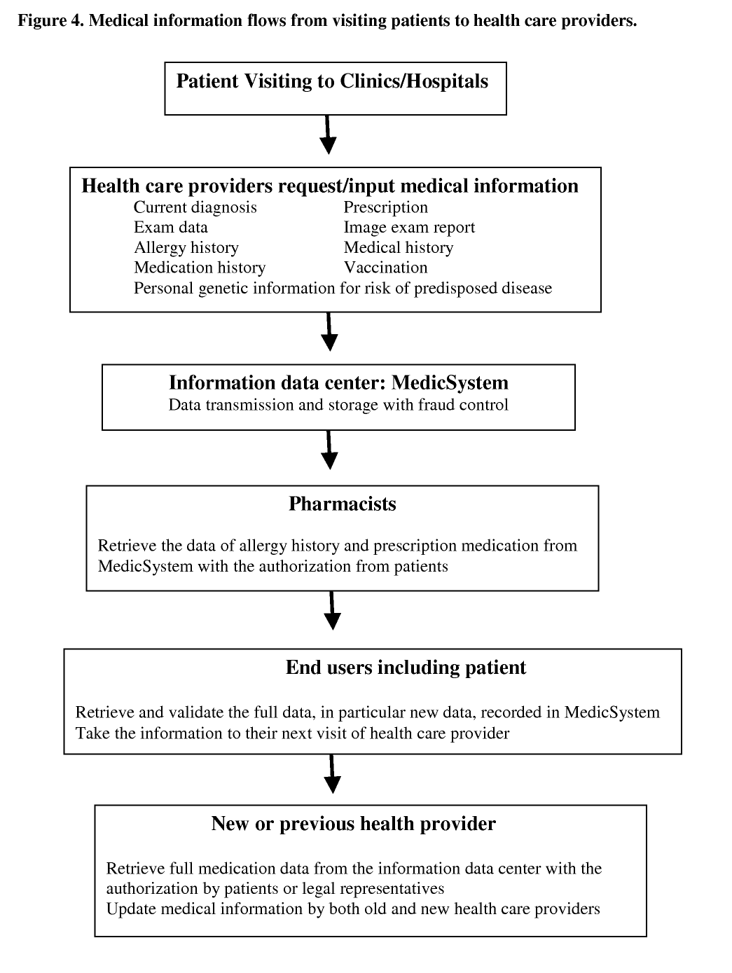

An embodiment of programmed flow chart for distribution of updated medical information from health care providers to visiting patients is illustrated in FIG. 4.

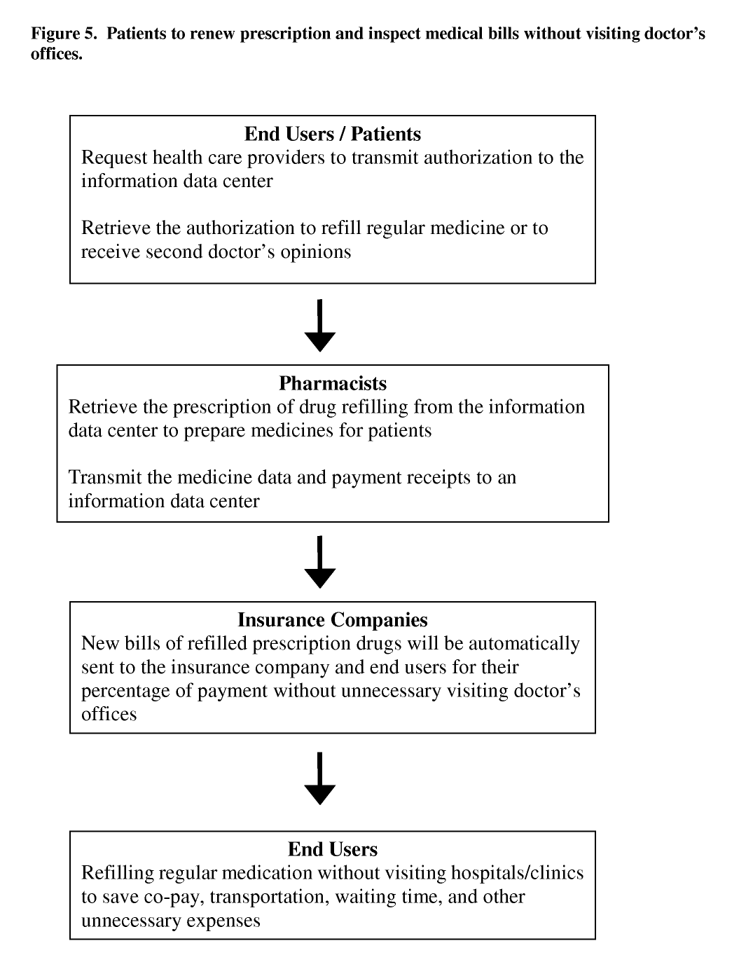

In one embodiment, a chronic-diseased patient may only need to renew his/her prescription to purchase medicine regularly or to receive a second doctor's opinions for disease treatment (FIG. 5). The end user may ask his/her medical doctor to send the authorization of prescription drug to the data information center, so the patient can refill his/her regular prescription medication at a desired drug store. The pharmacist at a designated store may also receive the prescription information from the information data center to confirm the authorization and give prescription medicine to the patient. The pharmacist can transmit the business transaction record to the information data center for storage. Finally, the insurance company may retrieve the purchase receipt and estimated cost provided by MedicSystem to finalize the medical bill issued to the patient.

In one embodiment, a patient does not need to visit a hospital or a clinic centers in person to renew his/her prescription. Not only can MedicSystem save a patient's co-pay medical expense, but also save fuel cost in transportation to doctor's office and waiting time at the drug store.

In another embodiment, a patient can make an appointment with a medical doctor directly through MedicSystem and receive a confirmation, preferable in real time, for the doctor appointment. A registered patient can retrieve his/her own medical history from MedicSystem. Upon request, MedicSystem will assist the patient to send the patient's health care information to a designated doctor for second opinions of medical treatment.

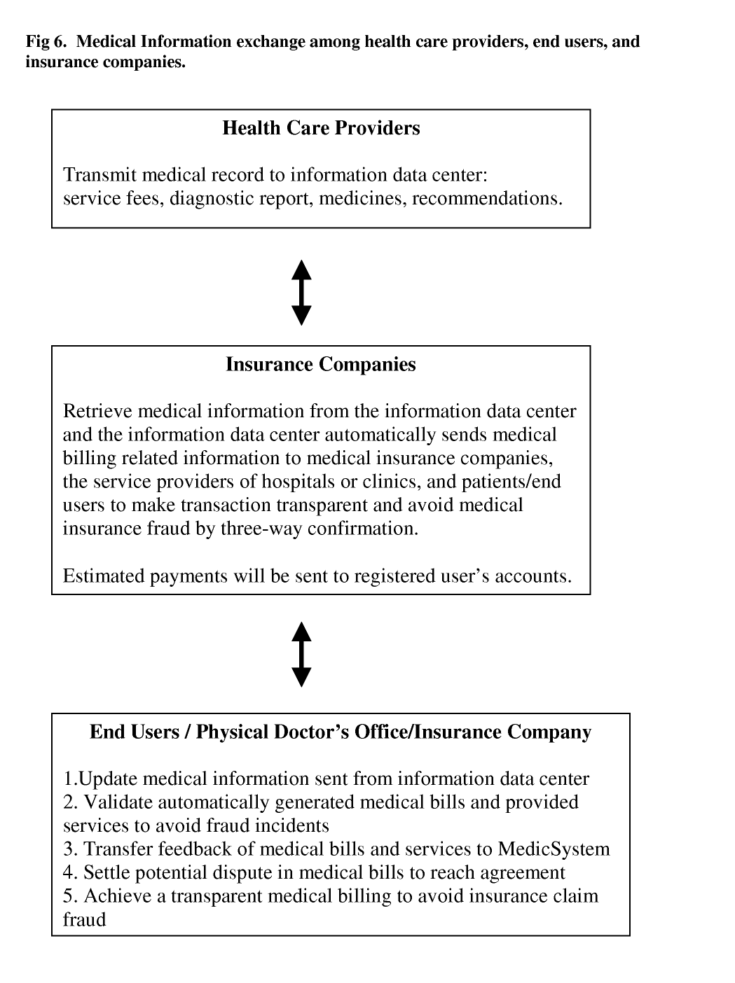

MedicSystem can serve as an information control center to direct and monitor the traffic of data exchange among various health care groups, including but not limited to health care providers, end users, and insurance companies (FIG. 6). One embodiment shown in FIG. 6, a health care provider, such as hospital or clinical center, submits new medical information to the MedicSystem information center after patient's visiting. The insurance company will receive notice to retrieve the medical information and estimated costs about the doctor's visiting sent from the information data center. Afterwards, the insurance company may evaluate the proposed medical bill and send the bill to the patient via MedicSystem. The end user or a patient, after receiving the medical bill, may agree or disagree the medical bill to pursuit a settlement. This process will make medical billing process become more transparent to reduce incidents of medical insurance fraud.

MedicSystem can further provide service to assist the settlement of medical payment bills for registered members and/or account holders through a medical billing specialist in the MedicSystem data center.

MedicSystem's operating software can perform cost comparison of prescription drugs, medical device, and other medical products for sale. An embodiment of a representative price comparison model is illustrated in FIG. 7.

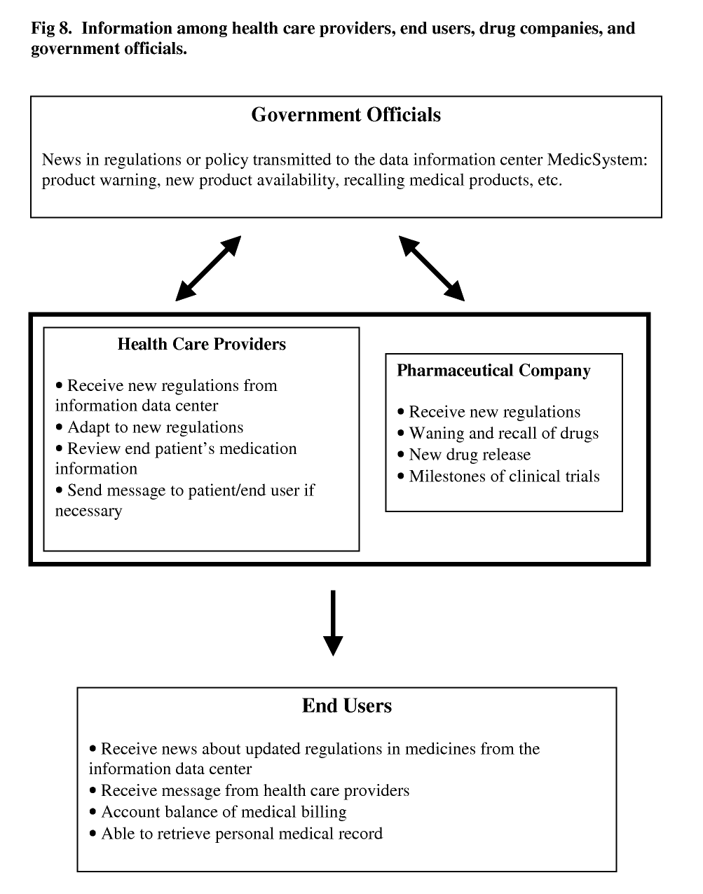

The government plays a central role in regulation of health care policy, new drug approval, warning of unsafe drugs, and recalling unsafe medical devices. MedicSystem collects new information released from government and distribute them to members/users as soon as they are available, preferable in real time using traditional phone call, Internet, and wireless transmission methods. In this embodiment (FIG. 8), we demonstrate how the medical information can be integrated into the network connection comprising health care providers, end users, drug companies, and government officials. After reviewing patient's information, health care providers can send message to related groups to modify the treatment or medication of patients, in particular for investigative drugs used in clinical trials.

In one aspect, MedicSystem demonstrates the advantages of paperless information storage and accuracy of data recognition without hand written letters leading to mistakes. In another aspect, MedicSystem can provide up-to-date drug safety information by issuing warnings to registered accounts as soon as FDA releases news to the public. In another aspect, the health care providers in hospitals or clinics can automatically receive the latest government regulatory policy routinely to prepare for the transition of new regulations and policies. The invention may make the adaptation of new regulations more efficiently and quickly at all levels of the health care professionals.

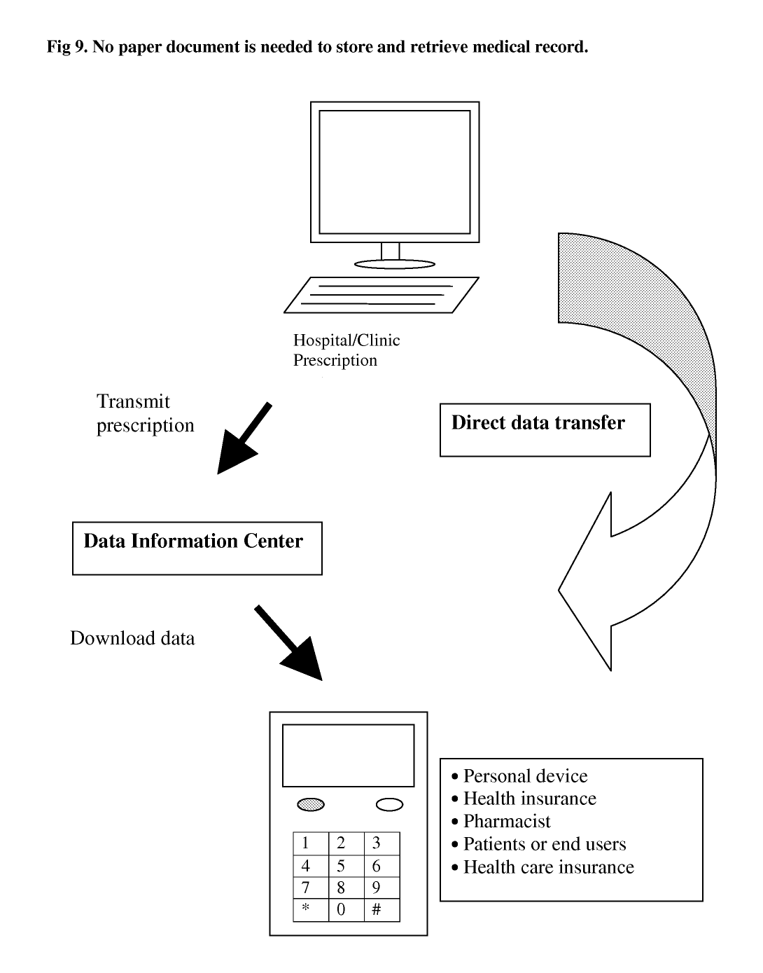

MedicSystem can save natural resources because no paper document is required to store and retrieve medical record for personal use. In this embodiment (FIG. 9), not only can users store prescription or personal health care information retrieved from the MedicSystem, but also use operating software to manage personalized medical care, such as automatically reminding of patients to taking medication on scheduled time, self-learning of health care matters, availability of new drugs or recall of a drug from the market, price comparison of medical products, and personal medical record.

The operating software stores basic information about medication drugs in a personal device, but can actively acquire more information from MedicSystem including drug name and brand, dosage of each pill, price comparison, and pictures of certain drugs. MedicSystem updates drug information when there is a new drug available in the market and a recalled drug off the market.

After getting the prescription from health care providers, end users can retrieve data from the MedicSystem data center illustrated in FIG. 9.

A representative instruction of taking multiple medicine daily is shown in the following. For example, it may list 1. Drug A, 1 pill, three times a day; 2. Drug B, 2 pills, four times a day; 3. Drug C, 1/2 pill, once in the morning every two days. This kind of data confuses end users and patients if they take various medicines in a given day. It is easy to mix up the dosage and frequency for medications. By using operating software, end users or patients can input the information as the sequence of taking their prescription. When patients input in these data, the operating software may search for information from its drug database stored at MedicSystem or personal devices, which will display dosage and image of a specific drug to solve issues of taking multiple medicine daily.

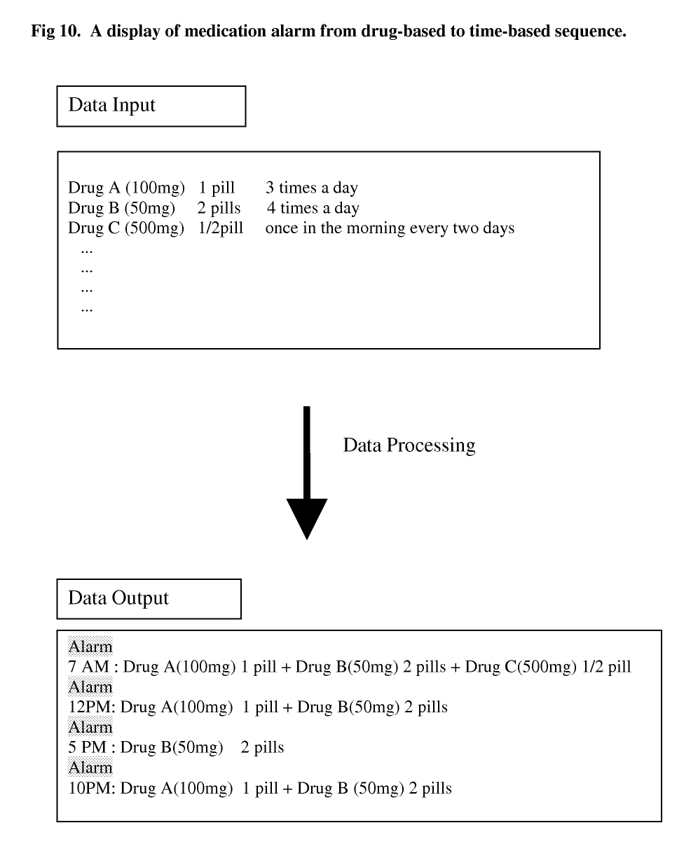

Through data processing, the operating software can conclude the dosage and frequency of all medication at a user-defined manner. It can alarm patients to take medicines at certain time in combination of other drug information. Taking the prior given example in, in the first day morning, the operating software will alarm and show Drug A, 1 pill; Drug B, 2 pills; Drug C, ½ pill; while at noon it only alarms and shows Drug A, 1 pill; Drug B, 2 pills; in the afternoon, it would alarm and show Drug B 2 pills; at night, the software would alarm and show Drug A 1 pill and Drug B 2 pills. In one embodiment shown in FIG. 10, the operating software can transform the data from drug-based instruction to time-based information. Also, it would help end users at appropriate time take their medication. By installing this data processing software, operating software, into a personal device, an end user or a patient can manage his/her own medical care information at ease.

The operating software can reduce human resources as well as costs of commuting time and operating expenses; thus, it benefits the most for long-term multiple medication patients, including patients with heart failure, diabetes, hypertension, cancer . . . etc. Account holders with same types of diseases can exchange opinions and share experience of life in managing the diseases. Furthermore, the MedicSystem can actively communicate to the users through operating software, preferable in wireless communication, to distribute new drug information, warning of drug safety issues, and user-defined information.

This invention can significantly improve the current health care system as a whole with respect to efficiency, precision, and accuracy in medical data management. Every stakeholder associated with the system receives certain benefits from information exchange via MedicSystem.

There are also tremendous risks in utilities of MedicSystem if government creates new laws and regulations to restrict utilities of personal medical information or health care societies are reluctant to adapt new technology or novel concept for health care information management.

### DEFINITION

MedicSystem is a health care information data center to receive, store, process, and distribute health care related information in real time to registered account holders.

Medical product is a general terminology comprising prescription and generic drugs, medical device, personalized medicine, diet supplement, therapeutic molecules comprising antibody, hormone, vaccine, and compound in liquid or solid formulation, consumable materials for medical care, and parts for medical devices.

End user is defined as a person who has the authority to use MedicSystem and/or operating software on behalf of a patient or a registered account holder.

Operating software is software installed in a personal device to perform at least two main functions: 1) manage personalized health care information and 2) communicate with the MedicSystem information center to send and/or retrieve data.

We claim:

1. A medical care management system to increase efficiency and accuracy of medical care administrating and/or to reduce personal spending in health care comprising:
(a) A health care information data center for storage, quality control, process, and distribution of health care related information;
(b) At least one health care information provider as a resource of updated health care information input into said data center; and
(c) At least one health care information recipient to retrieve information from said data center.

2. A medical care management system in claim 1 further comprising operating software installed in a personal device to manage personalized health care related information.

3. An information provider or an information receiver in claim 1 is selected from the group consisting of pharmacists, end users, patients, health insurance representatives, sales representatives of medical products including pharmaceutical drugs and medical devices, government officials, health care professionals, foreign travelers, medical tourists, and foreign medical service providers.

4. Health care information retrieved by a recipient in claim 1 is selected from the group consisting of personal identification, personal prescription medicine, personal genetic information, diagnosis report, medical report history, images of medical diagnostics, new drug approval and regulations, new drug advertising or recall, diseases prevention, insurance benefits and coverage, recommended doctors' contact, price comparison of medical products, and medical bills.

5. Health care information retrieved or submitted by a pharmacist to said data center in claim 1 is selected from the group consisting of past medication history of a drug user, new prescription drugs and their substitute drugs with price comparison, prescription drug order forms, new patient information, medication adherence record, warning/recalling drugs or diet supplements, purchase receipts and medical billings.

6. Health care information retrieved or submitted by a health care professional to said data center in claim 1 is selected from the group consisting of personal genetic information, personal medical history, allergy history, medication history, medical image report, prescription drug information, and medical bills.

7. Health care information retrieved or submitted by an insurance representative to said data center in claim 1 is selected from the group consisting of new laws and regulations, service claims from medical service providers, member benefits, claim forms, new insurance policy release, coverage of drugs, warning/recalling drugs, and diet supplements.

8. Health care information retrieved or submitted by a medical product sales representative to said data center in claim 1 is selected from the group consisting of advertising related to generic drugs, prescription drugs, medical devices, new drug pipelines and status in clinical trials, promotion of price/quote for medical products, and recalled medical products containing drugs and medical devices.

9. Health care information retrieved or submitted by an emergency channel representative to said data center in claim 1 is selected from the group consisting of uninsured people's medical information, medical history of foreign visitors and tourists, foreign medical service providers, and foreign health insurance companies.

10. A method using health care information from a medical information data center to reduce spending in health care service or in medical products comprising the steps of:
(a) Contacting said medical data center to request or download information;
(b) Retrieving health care information received from said data center using operating software;
(c) Programing and/or analyzing received information in a personalized setting;
(d) Making cost-effective decisions using computed results from step c.

11. A method according to claim 10, wherein said information is digitalized health care information.

12. A method according to claim 10 to reduce costs in prescription medicines or medical devices, wherein the provided information is physician's names having the authority to recommend prescription drugs and medical devices to lower advertising cost of product sales.

13. A method according to claim 10 to reduce cost in health care by identifying most potent prescription or generic drug(s) for a particular disease, wherein said information is statistical data using a particular drug and doctors' opinions on the drugs for disease treatment.

14. A method according to claim 10 to reducing health care cost by making medical billing process more transparent to reduce insurance fraudulent claims, wherein an estimated medical billing information will be sent to the insurer or patient, health care service providers, and insurance company representatives in an understandable manner to avoid false claims.

15. A method according to claim 10, wherein said information is the best rate of medical services or medical products computed by the operating software.

16. A method according to claim 10, wherein said information is medical record of foreign visitors and tourists.

17. A procedure to manage personal health care, including medication adherence, using operation software comprising the steps of:
(a) Applying for an user account connecting to a medical data center;
(b) Installing a first software in a device to retrieve medical record from and send updated medical information to a medical data center;
(c) Installing a second software in said device to convert drug-based information to time-based information;
(d) Setting an alarm system to remind users for actions by said device or by user-defined requirements programmed in said medical data center; and
(e) Taking the action in response to the alarms.

18. According to claim 17, wherein device is a digital media information storage device selected from the group consisting of a server for centralized data management, a personal device, a cell phone, PAD, a computer, CD, tape, a portable voice recorder, a portable USB driver, and an image displayer.

19. A method according to claim 17, wherein the users are health care professionals, comprising medical doctors, nurses, caregivers in senior care centers, in nursing homes, or other private caregivers.

20. A method in claim 17, wherein the users are individual account holders for self-management of medication and/or personalized health care.
